(19) United States
(12) Patent Application Publication
(10) Pub. No.: US 2007/0292600 A1
(43) Pub. Date: Dec. 20, 2007

(54) PRESSED POWDER PELLET BATTERY ELECTRODE SYSTEM

(76) Inventor: Adam J. Morgan, Cottage Grove, MN (US)

Correspondence Address: SCHWEGMAN, LUNDBERG & WOESSNER, P.A., P.O. BOX 2938, MINNEAPOLIS, MN, 55402, US

(21) Appl. No.: 11/424,976

(22) Filed: Jun. 19, 2006

(51) Int. Cl. B05D 5/12; H01M 4/04; B05C 11/02

(52) U.S. Cl. 427/58; 118/121; 29/623.5

(57) ABSTRACT

A method of manufacturing a pressed powder electrode for an electrochemical power source for use with an implantable medical device is provided. The method includes surrounding a current collector with layered sections of electrode powder. The method also includes compacting the electrode powder against the current collector from opposite sides to form an electrode pellet using springs having spring constants calculated to relieve a gap difference in equal strokes from each side. The resulting electrode pellet includes a substantially centered collector. According to various embodiments, compacting the electrode powder includes compacting using at least two springs on opposite sides of the current collector. Compacting the electrode powder includes using at least one forced air supply to compact the powder, according to various embodiments. Other aspects and embodiments are provided herein.

### TECHNICAL FIELD

This disclosure relates to electrochemical power sources, particularly pressed powder pellet battery electrode systems.

### BACKGROUND

Certain devices have been developed to operate using batteries with pressed powder pellet electrodes. Battery cathodes require a current collector to lower impedance. Both loading and compaction can affect alignment of the current collector. In a traditional two-stage compaction process, the powder is loaded into a die, and a mass (or piston) is used to compact or compress the powder into a first section of pressed pellet. The current collector (or tab) is then inserted and another layer of powder is placed over the compacted powder and the mass is used to compact or compress the powder into a second section of pressed pellet. The next step, or second compaction stage, involves compacting the two sections of pressed pellet against the current collector to produce the resulting cathode pellet.

Various methods can be used for the second compaction stage, each with its own parameters (e.g. rate, collector centering technique, etc.), all subject to the flow dynamics of the powder used. Controlling collector movement and the rate of compaction of the piston during the second compaction stage effects placement (centering) of the current collector. Various methods used to substantially center the collector include: one-sided compaction allowing the collector to slide; one-sided compaction while forcing collector tab movement at a different rate than the piston compaction; or two-sided compaction with a fixed collector. Adhesion about the collector maintains integrity of the electrode.

Two-stage compaction has the disadvantages of requiring more process steps, multiple dies, and may have binding problems with pre-compacted powder (sections of pressed pellet). Once compressed, the pre-compacted powder binder does not adhere as well to itself. The current collector is encompassed within the pressed powder pellet electrode using multiple steps, which reduces consistency and increases the difficulty in automating the process. Improved pressed powder pellet battery electrodes and systems for manufacturing electrodes are needed.

### SUMMARY

Disclosed herein, among other things, is a method of manufacturing a pressed powder electrode for an electrochemical power source for use with an implantable medical device. The method includes surrounding a current collector with layered sections of electrode powder. The method also includes compacting the electrode powder against the current collector from opposite sides to form an electrode pellet using springs having spring constants calculated to relieve a gap difference in equal strokes from each side. The resulting electrode pellet includes a substantially centered collector. According to various embodiments, compacting the electrode powder includes compacting using at least two springs on opposite sides of the current collector. Compacting the electrode powder includes using at least one forced air supply to compact the powder, according to various embodiments.

One aspect of this disclosure relates to a system for manufacturing a pressed powder electrode for an electrochemical power source for use with an implantable medical device. The system includes a die adapted to hold a current collector and having an aperture. The system also includes two pistons adapted to movably extend through the aperture and further adapted to compact electrode powder against the current collector from opposite sides. The system further includes at least two springs connected to the pistons, the springs having spring constants calculated to relieve gap difference in equal strokes from each side. According to an embodiment, the resulting electrode pellet includes a substantially centered collector.

This Summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

FIG. 1 illustrates a schematic diagram of a system for manufacturing a pressed powder electrode for an electrochemical power source, according to one embodiment.

FIG. 2 illustrates a schematic diagram of a system, including springs, for manufacturing a pressed powder electrode, according to one embodiment.

FIG. 3 illustrates a schematic diagram of a system, including an air supply, for manufacturing a pressed powder electrode, according to one embodiment.

FIG. 4 illustrates a block diagram of an electrochemical power source for use with an implantable medical device, according to one embodiment.

FIG. 5 illustrates a block diagram of a generic implantable medical device including an electrochemical power source, according to one embodiment.

FIG. 6 illustrates a flow diagram of a method of manufacturing a pressed powder electrode for an electrochemical power source, according to one embodiment.

FIG. 7 illustrates a flow diagram of a method of forming an electrochemical power source for use with an implantable medical device, according to one embodiment.

### DETAILED DESCRIPTION

The following detailed description refers to the accompanying drawings which show, by way of illustration, specific aspects and embodiments in which the present invention may be practiced. These embodiments are described in sufficient detail to enable those skilled in the art to practice the invention. Other embodiments may be utilized and structural, logical, and electrical changes may be made without departing from the scope of the present invention.

A single-stage compaction system for pressed powder electrodes is described herein. The system relieves the need for pre-compacting the powder. The present disclosure provides for the use of controlled compaction of powder around a fixed collector to allow single stage compaction and provide a substantially centered location of the current collector in the cathode. A centered collector aids in the prediction of battery life tests and optimizes impedance in a battery cell. The electrode is compressed substantially simultaneously from both directions while the collector is held in place, allowing for better flow of powder in and about the collector. Single stage compaction allows for more consistent manufacturing results and increased ease of process automation.

### System for Manufacturing a Pressed Powder Electrode

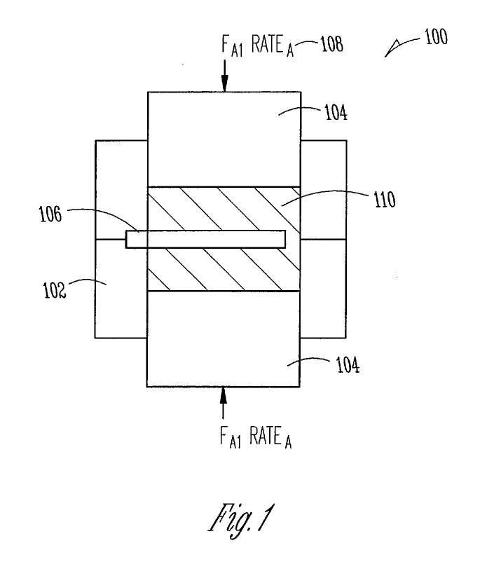

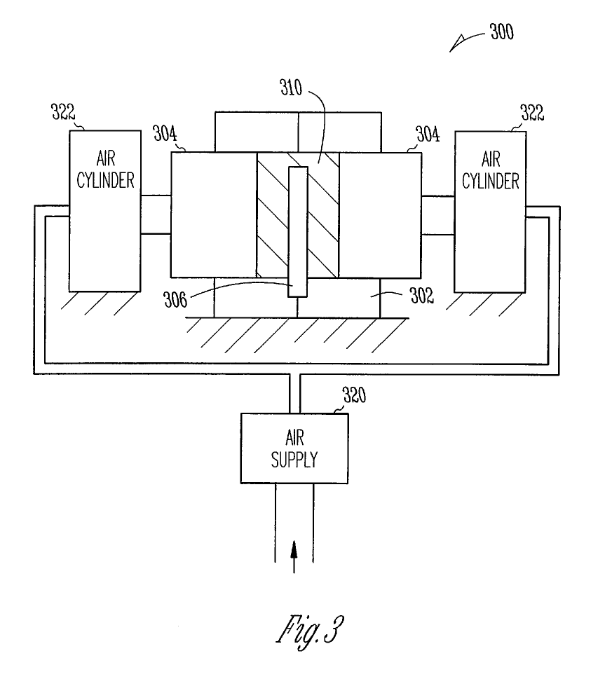

FIG. 1 illustrates a schematic diagram of a system for manufacturing a pressed powder electrode for an electrochemical power source, according to one embodiment. The system 100 includes means for centering 102 and holding a current collector 106 between at least two pistons 104. The current collector is shaped to match the shape of the die and has a grid on its surface to provide for better adhesion of powder. According to various embodiments, the collector has a cylindrical shape. Other shapes are possible without departing from the scope of this disclosure. The centering means 102 may include a die or other type of clamp in various embodiments. The system embodiment also includes means for compacting 108 the electrode powder 110 against the current collector 106 from opposite sides using spring constants calculated to relieve a gap difference in equal strokes from each side. The gap difference indicates the distance from the first piston to the collector or the distance from the second piston to the collector, according to various embodiments. The compacting means 108 may include the pistons 104 and actuator for forcing the pistons together (see FIG. 3, for example) and interior sides of the die. According to an embodiment, the resulting electrode pellet includes a substantially centered current collector.

According to various embodiments of the system, the pistons are adapted to be actuated using springs. Various embodiments of the system use standard die springs. The powder 110 can include CFx (carbon monofluoride) with a conductive filler such as graphite or acetylene black, and a binder, such as PTFE (polytetrafluoroethylene) according to an embodiment. The binder includes a carbon-based conductive material according to various embodiments. The current collector 106, or tab, includes a stainless steel material in an embodiment. The tab may be constructed of nickel, aluminum, or other metals in various embodiments.

The pistons 104 are adapted to be actuated using forced air, hydraulics, a servo-motor, or any mechanism to deliver force equally to both pistons, according to various embodiments. The resulting electrode pellet can be adapted to be used in a battery for powering an implantable medical device. Examples of implantable medical devices include pacemakers, defibrillators, neurostimulators, among others. The present system can be incorporated into any pressed powder medium rate battery.

One aspect of this disclosure relates to a system for manufacturing a pressed powder electrode for an electrochemical power source for use with an implantable medical device. The system includes means for surrounding a current collector with layered sections of electrode powder. The surrounding means can include a die or other (usually metallic, although composites could be used in an embodiment) structure. The system also includes means for compacting the electrode powder against the current collector from opposite sides using springs having spring constants calculated to relieve a gap difference in equal strokes from each side. The gap difference indicates the distance from the first piston to the collector or the distance from the second piston to the collector, according to various embodiments. According to an embodiment of the system, the resulting electrode pellet includes a substantially centered current collector. The means for surrounding a current collector includes at least one clamping means, according to an embodiment. The clamping means holds the current collector parallel to the face of the compacting means, in an embodiment. The compacting means includes at least one forced air adapted to supply forced air to at least two opposing air cylinders to compact powder from opposite sides of the collector, according to one embodiment.

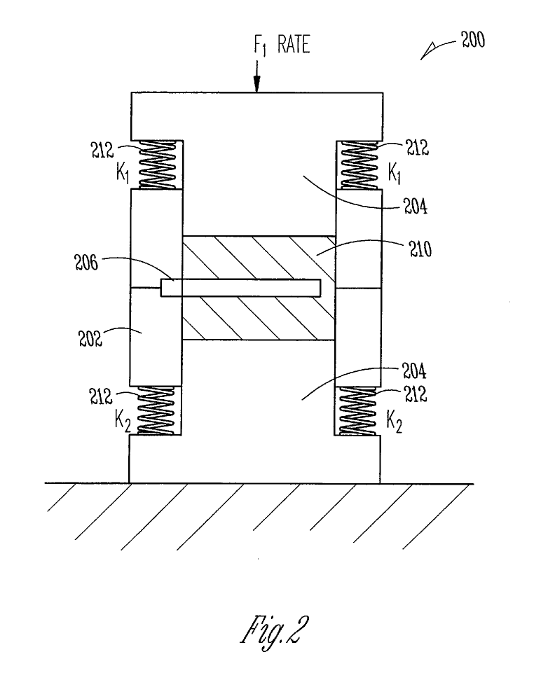

FIG. 2 illustrates a schematic diagram of a system, including springs, for manufacturing a pressed powder electrode, according to one embodiment. An embodiment of the system 200 for manufacturing a pressed powder electrode includes a die 202 adapted to hold a current collector 206 and having an aperture. The system also includes two pistons 204 adapted to movably extend through the aperture and further adapted to compact electrode powder 210 against the current collector from opposite sides. The system further includes at least two springs 212 connected to the pistons 204, the springs having spring constants calculated to relieve gap difference in equal strokes from each side. The gap difference indicates the distance from the first piston to the collector or the distance from the second piston to the collector, according to various embodiments. The spring constants K₁ of the top springs can be different than the spring constants K₂ of the bottom springs. According to an embodiment, the top springs are twice as stiff so that the collector will maintain a central position between the pistons during compaction. According to an embodiment, the resulting electrode pellet includes a substantially centered collector.

The die 202 may be adapted to hold the current collector in a variety of different orientations with respect to the die, according to various embodiments. A groove may exist in the die to allow the tab to move, according to an embodiment. The resulting electrode pellet can be used in a battery for powering implantable medical devices, such as pacemakers, defibrillators, neurostimulators, among others. The present system can be incorporated into any pressed powder medium rate battery.

FIG. 3 illustrates a schematic diagram of a system, including an air supply, for manufacturing a pressed powder electrode, according to one embodiment. An embodiment of the system 300 for manufacturing a pressed powder electrode includes a die 302 adapted to hold a current collector 306 and having an aperture. The system also includes two pistons 304 adapted to movably extend through the aperture and further adapted to compact electrode powder 310 against the current collector from opposite sides. The system further includes at least one forced air supply 320 adapted to supply forced air to at least two opposing air cylinders 322 to compact powder from opposite sides of the collector, the force of the applied air calculated to relieve gap difference in equal strokes from each side. The gap difference indicates the distance from the first piston to the collector or the distance from the second piston to the collector, according to various embodiments. According to an embodiment, the resulting electrode pellet includes a substantially centered collector.

### Electrochemical Power Source for Use with an Implantable Medical Device

FIG. 4 illustrates a block diagram of an electrochemical power source for use with an implantable medical device, according to one embodiment. The electrochemical power source 400 includes a housing 402 and at least one anode 404, at least one cathode 406, and an electrolyte 408 within the housing. According to an embodiment of the system, at least one of the anode and the cathode (in this case the cathode 406) includes a pressed powder pellet electrode with a substantially centered current collector that has been manufactured by inserting the current collector before compacting the powder. According to various embodiments, a separator material 405 holds the anode away from the cathode. The separator material 405 may include a material having a porous membrane, according to an embodiment. The cathode may be connected to a terminal (not show) extending out from the end of the housing, in an embodiment. The anode and cathode are isolated from each other, according to various embodiments.

In various embodiments, the cathode 406 may include compressed powder, dough or slurry. The cathode can be formed directly in the battery container or pressed or coated onto an electrically conductive material. In various embodiments, the cathode includes at least one metal oxide, metal sulphide, metal selenide, metal halide or metal oxyhalide compound or their corresponding lithiated forms. The cathode may include manganese, vanadium, silver, molybdenum, tungsten, cobalt, nickel, or chromium. The cathode may also include a main group compound such as carbon monofluoride or iodine. Other compositions of the cathode are within the scope of this disclosure.

The anode 404 may include carbon or a metal, according to various embodiments. The anode may include metals such as lithium, sodium, potassium, rubidium, cesium, magnesium, calcium, strontium, barium, tin, zinc or silver. Other compositions of the anode are within the scope of this disclosure.

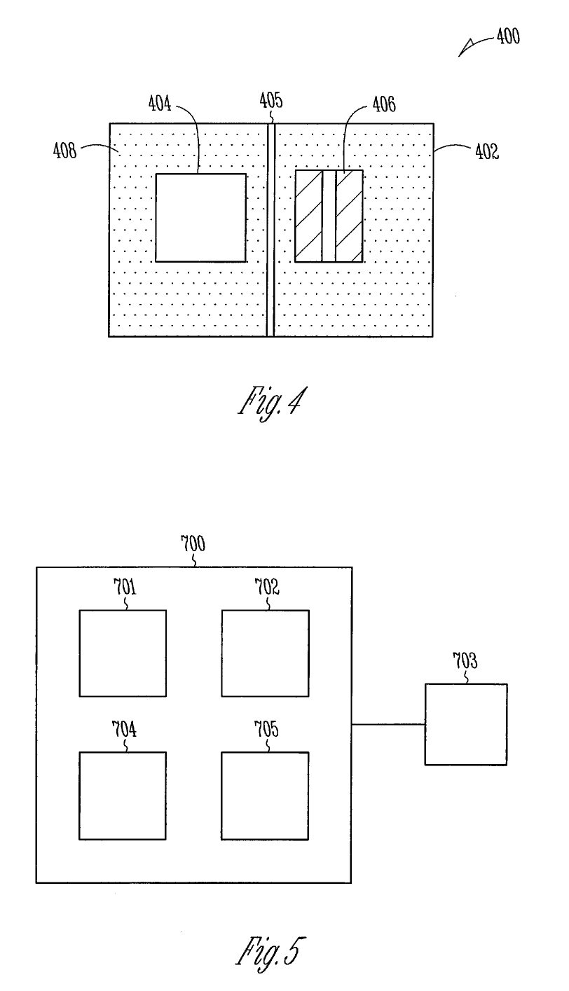

Certain implantable medical devices (IMDs) have been developed to operate using batteries with pressed powder pellet electrodes. FIG. 5 illustrates a block diagram of a generic implantable medical device 700 including an electrochemical power source, according to one embodiment. An implantable heart monitor is one of the many applications for electrochemical power sources incorporating one or more teachings of the present subject matter. As used herein, implantable heart monitor includes any implantable device for providing therapeutic stimulus to a heart muscle. Thus, for example, the term includes pacemakers, defibrillators, cardioverters, congestive heart failure devices, and combinations and permutations thereof.

Implantable medical device 700 can include a lead system 703, which after implantation electrically contact strategic portions of a patient's organs or vessels. Shown schematically are portions of device 700 including a monitoring circuit 702 for monitoring activity through one or more of the leads of lead system 703, and a therapy circuit 701 for delivering electrical energy through one or more of the leads to a patient. The device 700 also includes an energy storage component, which includes a capacitor 705 and incorporates at least one electrochemical power source, or battery 704, having one or more of the features of the capacitor embodiments described above. In addition to implantable heart monitor and other cardiac rhythm management devices, one or more teachings of the present system can be incorporated into electrochemical power sources used for other IMDs, such as neurostimulators, or into photographic flash equipment. The present system can be incorporated into any pressed powder medium rate battery.

According to an embodiment, medical device circuitry includes sensor circuitry adapted to provide a diagnostic function. The medical device circuitry may also include stimulation circuitry adapted to provide a therapeutic function, such as neurostimulation circuitry adapted to provide neurostimulation therapy. The medical device circuitry may include both sensor circuitry and stimulation circuitry. According to various embodiments, the electrochemical power source includes multiple electrodes electrically connected in series, connected in parallel, or connected in a combination of series and parallel, to provide the necessary electrical current to power the implantable medical device.

### Method of Manufacturing a Pressed Powder Electrode

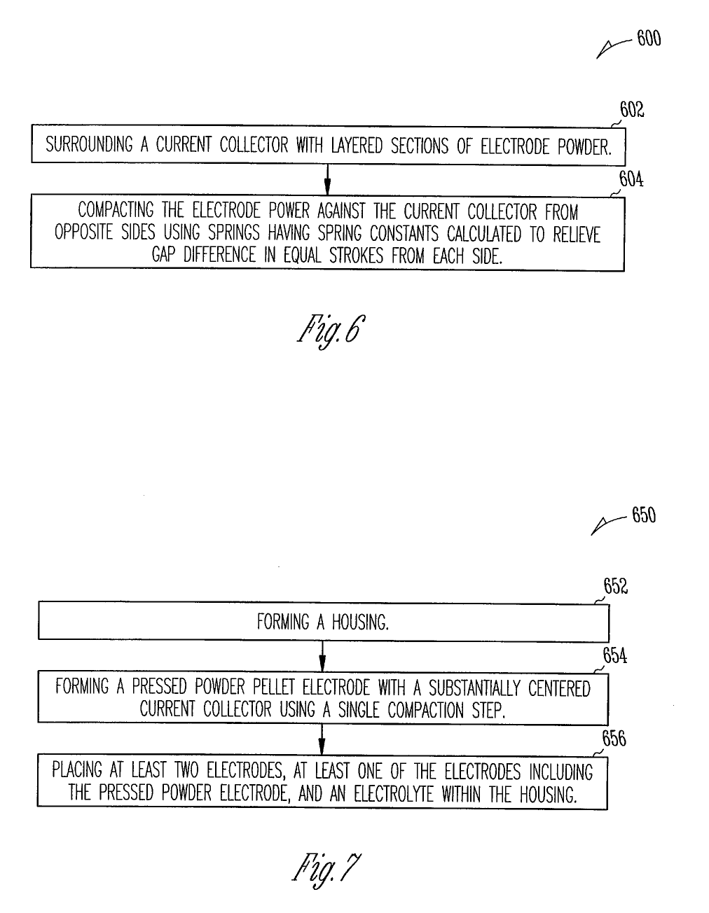

FIG. 6 illustrates a flow diagram of a method of manufacturing a pressed powder electrode for an electrochemical power source, according to one embodiment. The method 600 includes surrounding a current collector with layered sections of electrode powder, at 602. The method also includes compacting the electrode powder against the current collector from opposite sides to form an electrode pellet using springs having spring constants calculated to relieve a gap difference in equal strokes from each side, at 604. The gap difference indicates the distance from the first piston to the collector or the distance from the second piston to the collector, according to various embodiments. The resulting electrode pellet includes a substantially centered collector. According to various embodiments, compacting the electrode powder includes compacting using at least two springs on opposite sides of the current collector. Compacting the electrode powder includes using at least one forced air supply to compact the powder, according to various embodiments.

According to an embodiment, compacting the electrode powder includes compacting the electrode powder from each side substantially simultaneously. Surrounding the current collector includes holding the current collector in a fixed position using a die, according to various embodiments.

### Method of Forming an Electrochemical Power Source

FIG. 7 illustrates a flow diagram of a method of forming an electrochemical power source for use with an implantable medical device, according to one embodiment. The method 650 includes forming a housing, at 652. The method also includes forming a pressed powder pellet electrode with a substantially centered current collector using a single compaction step, at 654. The method further includes placing at least two electrodes, at least one of the electrodes including the pressed powder electrode, and an electrolyte within the housing, at 656.

According to various embodiments, forming the pressed powder electrode includes pressing CFx powder. Forming the pressed powder electrode includes forming the electrode with a nickel, aluminum or stainless steel current collector, according to various embodiments.

One of ordinary skill in the art will understand that, the modules and other circuitry shown and described herein can be implemented using software, hardware, and combinations of software and hardware. As such, the illustrated modules and circuitry are intended to encompass software implementations, hardware implementations, and software and hardware implementations.

The methods illustrated in this disclosure are not intended to be exclusive of other methods within the scope of the present subject matter. Those of ordinary skill in the art will understand, upon reading and comprehending this disclosure, other methods within the scope of the present subject matter.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. A method, comprising:
surrounding a current collector with layered sections of electrode powder; and
compacting the electrode powder against the current collector from opposite sides to form an electrode pellet using springs having spring constants calculated to relieve a gap difference in equal strokes from each side, wherein the resulting electrode pellet includes a substantially centered collector.

2. The method of claim 1, wherein compacting the electrode powder includes compacting the electrode powder from each side substantially simultaneously.

3. The method of claim 1, wherein compacting the electrode powder includes compacting using at least two springs on opposite sides of the current collector.

4. The method of claim 1, wherein surrounding the current collector includes holding the current collector in a fixed position using a die.

5. The method of claim 1, wherein compacting the electrode powder includes using at least one forced air supply to compact the powder.

6. A system, comprising:
means for surrounding a current collector with layered sections of electrode powder; and
means for compacting the electrode powder against the current collector from opposite sides using springs having spring constants calculated to relieve a gap difference in equal strokes from each side, wherein a resulting electrode pellet includes a substantially centered current collector.

7. The system of claim 6, wherein the means for surrounding a current collector includes at least one clamping means.

8. The system of claim 7, wherein the at least one clamping means holds the current collector parallel to the face of the compacting means.

9. The system of claim 6, wherein the compacting means includes at least one forced air supply to compact the powder.

10. The system of claim 9, wherein the at least one forced air supply is adapted to supply forced air to at least two opposing air cylinders to compact powder from opposite sides of the collector.

11. A system, comprising:
means for centering and holding a current collector between at least two pistons;
means for compacting the electrode powder against the current collector from opposite sides using spring constants calculated to relieve a gap difference in equal strokes from each side, wherein a resulting electrode pellet includes a substantially centered current collector.

12. The system of claim 11, wherein the pistons are adapted to be actuated using springs.

13. The system of claim 11, wherein the pistons are adapted to be actuated using forced air.

14. The system of claim 11, wherein the resulting electrode pellet is adapted to be used in a battery for powering an implantable medical device.

15. The system of claim 14, wherein the implantable medical device includes a pacemaker.

16. A system, comprising:
a die adapted to hold a current collector and having an aperture;
two pistons adapted to movably extend through the aperture and further adapted to compact electrode powder against the current collector from opposite sides;
at least two springs connected to the pistons, the springs having spring constants calculated to relieve gap difference in equal strokes from each side, wherein a resulting electrode pellet includes a substantially centered collector.

17. The system of claim 16, wherein the electrode powder includes carbon monofluoride.

18. The system of claim 16, wherein the electrode powder includes polytetrafluoroethylene.

19. The system of claim 16, wherein the resulting electrode pellet is adapted to be used in a battery for powering an implantable medical device.

20. The system of claim 19, wherein the implantable medical device includes a defibrillator.

21. A method, comprising:
forming a housing;
forming a pressed powder pellet electrode with a substantially centered current collector using a single compaction step; and
placing at least two electrodes, at least one of the electrodes including the pressed powder electrode, and an electrolyte within the housing.

22. The method of claim 21, wherein forming the pressed powder electrode includes pressing carbon monofluoride powder.

23. The method of claim 21, wherein forming the pressed powder electrode includes forming the electrode with an aluminum current collector.

24. The method of claim 21, wherein forming the pressed powder electrode includes forming the electrode with a stainless steel current collector.

25. The method of claim 21, wherein forming the pressed powder electrode includes forming the electrode with a nickel current collector.
